(19) United States
(12) Patent Application Publication
(10) Pub. No.: US 2006/0113719 A1
(43) Pub. Date: Jun. 1, 2006

(54) Non-contact transport apparatus

(75) Inventors: Shigekazu Nagai, Adachi-ku (JP); Akio Saitoh, Kawaguchi-shi (JP); Masahiko Someya, Ryugasaki-shi (JP)

Correspondence Address: PAUL A. GUSS;PAUL A. GUSS ATTORNEY AT LAW, 775 S 23RD ST FIRST FLOOR SUITE 2, ARLINGTON, VA, 22202, US

(73) Assignee: SMC Kabushiki Kaisha, Tokyo (JP)

(21) Appl. No.: 11/240,596

(22) Filed: Oct. 3, 2005

(30) Foreign Application Priority Data
Nov. 29, 2004 (JP) 2004-344929

(51) Int. Cl. B65G 49/07; B23Q 3/00

(52) U.S. Cl. 269/20; 414/935

(57) ABSTRACT

A non-contact transport apparatus comprises a top plate, which is formed with an air supply hole, an under plate, which is formed with a plurality of air-jetting holes, and a plurality of intermediate plates, which are stacked and interposed between the top plate and the under plate. The intermediate plates are formed with slits therein functioning as nozzles and fluid passages that communicate with the air supply hole and the air-jetting holes. Screw members are provided, which integrally connect the top plate, the plurality of intermediate plates, and the under plate.

### BACKGROUND OF THE INVENTION

1. Field of the Invention

The present invention relates to a non-contact transport apparatus capable of, for example, retaining, transporting, and rotating a workpiece in a non-contact state.

2. Description of the Related Art

In recent years, non-contact transport has been intensively demanded for the transport of thin sheet-shaped wafers, in response to demands for IC cards and the like, and for transporting film-shaped parts that are used in liquid crystals and plasma displays. In response to such a demand, a non-contact transport apparatus has been suggested, which utilizes the Bernoulli effect, brought about by the flow of gas or air when a workpiece is transported in a non-contact manner.

For example, Japanese Laid-Open Patent Publication No. 11-254369 discloses a non-contact transport apparatus, which is provided with a swirling chamber communicating with an air inlet port, for generating a swirling flow of air therein, and which is provided with a bell mouth communicating with the swirling chamber and having a surface opposed to a transport objective, wherein the transport objective is retained in a non-contact manner utilizing the Bernoulli effect brought about by air flow generated between the bell mouth and the transport objective.

On the other hand, as shown in FIG. 20, Japanese Laid-Open Patent Publication No. 2002-64130 discloses a non-contact transport apparatus 5, which is provided with recesses 1 having inner circular circumferential surfaces, a flat surface 3 formed on an open side of the recesses 1 and opposed to a wafer (transport objective) 2, and unillustrated fluid passages for discharging a supplied fluid from unillustrated jetting holes facing the inner circumferential surfaces of the recesses 1 into the recesses 1, along the inner circumferential directions of the recesses 1. Air, which is supplied from fluid-introducing ports 4, is used to provide a high speed air flow that flows between the flat surface 3 and the wafer 2, so that negative pressure is generated in accordance with the Bernoulli effect to lift the wafer 2, while the flat surface 3 and the wafer 2 are kept in a non-contact state by the aid of the positive pressure high speed air flow that flows between the flat surface 3 and the wafer 2.

However, in the case of the technical concepts disclosed in Japanese Laid-Open Patent Publication Nos. 11-254369 and 2002-64130, when the number of the recesses for jetting the swirling flow toward the workpiece is increased so that the film-shaped workpiece, which is easily deformable by external forces, can be transported in a non-contact manner without strain, then the number of steps for forming the fluid passages that communicate between the fluid-introducing port to the recesses is increased, and the production cost becomes expensive.

Further, in the case of the technical concepts disclosed in Japanese Laid-Open Patent Publication Nos. 11-254369 and 2002-64130, the jetting hole, which functions as a nozzle for jetting an air flow having an increased flow speed, is formed by a minute hole. If it is intended to bore the hole accurately by using, for example, a drill, then the number of forming steps is increased, and the production cost becomes more expensive.

### SUMMARY OF THE INVENTION

A general object of the present invention is to provide a non-contact transport apparatus, which is easily produced, and which makes it possible to reduce the number of forming steps, so that the production cost is inexpensive.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a perspective view illustrating a non-contact transport apparatus according to an embodiment of the present invention;

FIG. 2 is an exploded perspective view illustrating the non-contact transport apparatus shown in FIG. 1;

FIG. 3 is a perspective view as viewed in the direction of the arrow Z shown in FIG. 1;

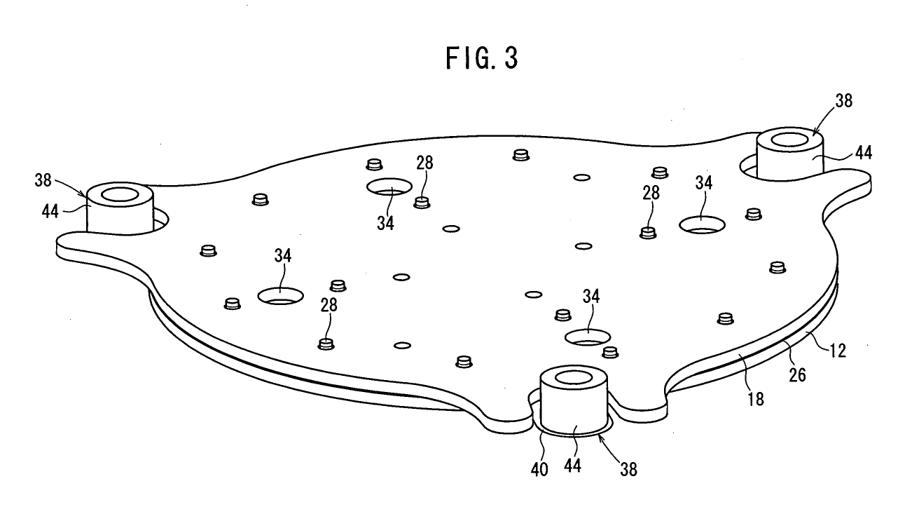

FIG. 4 is, with partial omission, a magnified exploded perspective view illustrating a disengagement-preventive guide mechanism;

FIG. 5 is a partial magnified perspective view illustrating a nozzle and an air-jetting hole provided for the non-contact transport apparatus shown in FIG. 1;

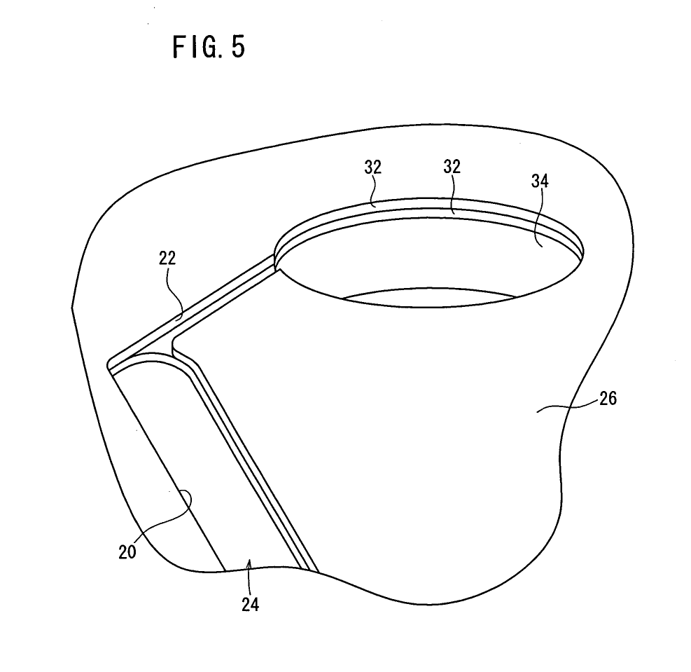

FIG. 6 is a perspective view illustrating a non-contact transport apparatus according to another embodiment of the present invention;

FIG. 7 is an exploded perspective view illustrating the non-contact transport apparatus shown in FIG. 6;

FIG. 8 is a perspective view as viewed in the direction of the arrow Z shown in FIG. 6;

FIG. 9 is a perspective view illustrating various plates;

FIG. 10 is a perspective view illustrating second under plates, which are stacked for forming air-jetting holes;

FIG. 11 is a partial magnified perspective view illustrating a state in which a main sensor body and a sensor plate are installed;

FIG. 12 is a partial magnified perspective view illustrating a state in which the main sensor body and the sensor plate are installed to a sensor attachment section;

FIG. 13 is a partial magnified perspective view as viewed in the direction of the arrow Z shown in FIG. 12;

FIG. 14 is a partial magnified perspective view illustrating a state in which a first fin is flexibly bent upwardly when the main sensor body is inserted into a fitting groove;

FIG. 15 is a partial magnified perspective view illustrating the structure of the main sensor body;

FIG. 16 is a partial magnified perspective view illustrating a state in which the sensor plate is installed into a nut-inserting groove;

FIG. 17 is a partial magnified perspective view as viewed in the direction of the arrow Z shown in FIG. 16;

FIG. 18 is a partial magnified perspective view illustrating a groove for accommodating a cable therein;

FIG. 19 is another partial magnified perspective view illustrating the groove for accommodating the cable therein; and

FIG. 20 is a perspective view illustrating a non-contact transport apparatus in accordance with a conventional technique.

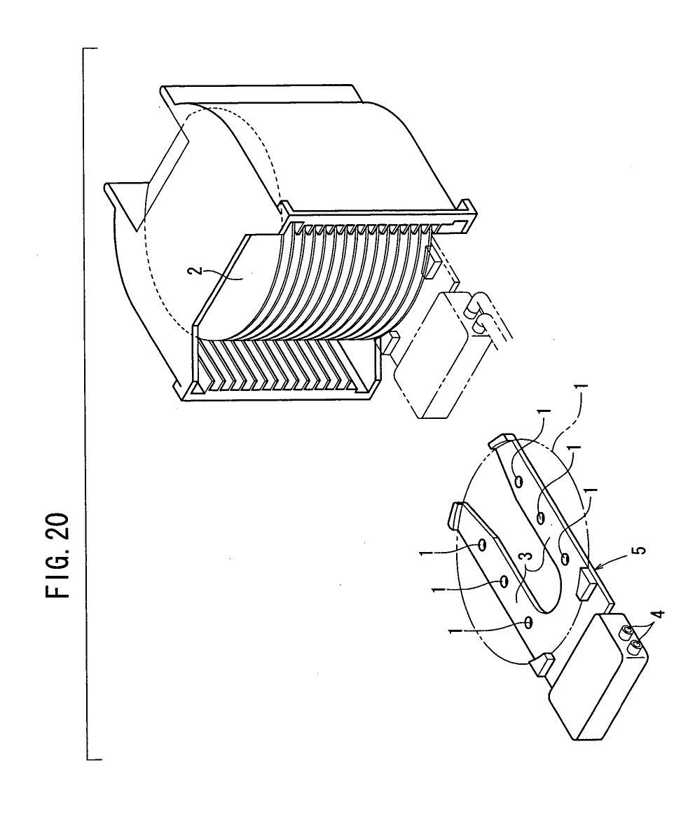

### DESCRIPTION OF THE PREFERRED EMBODIMENTS

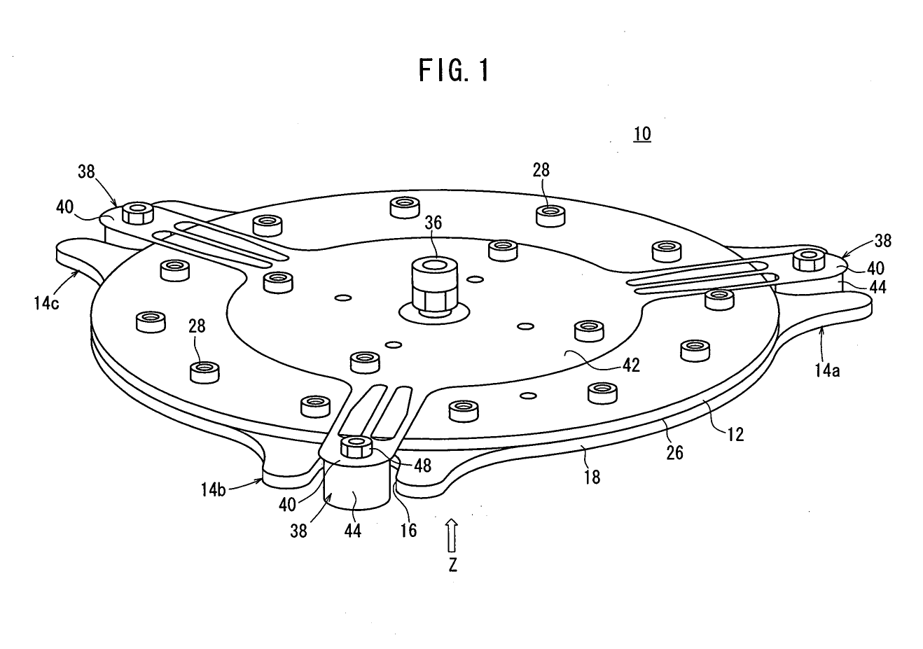

With reference to FIG. 1, reference numeral 10 indicates a non-contact transport apparatus according to an embodiment of the present invention.

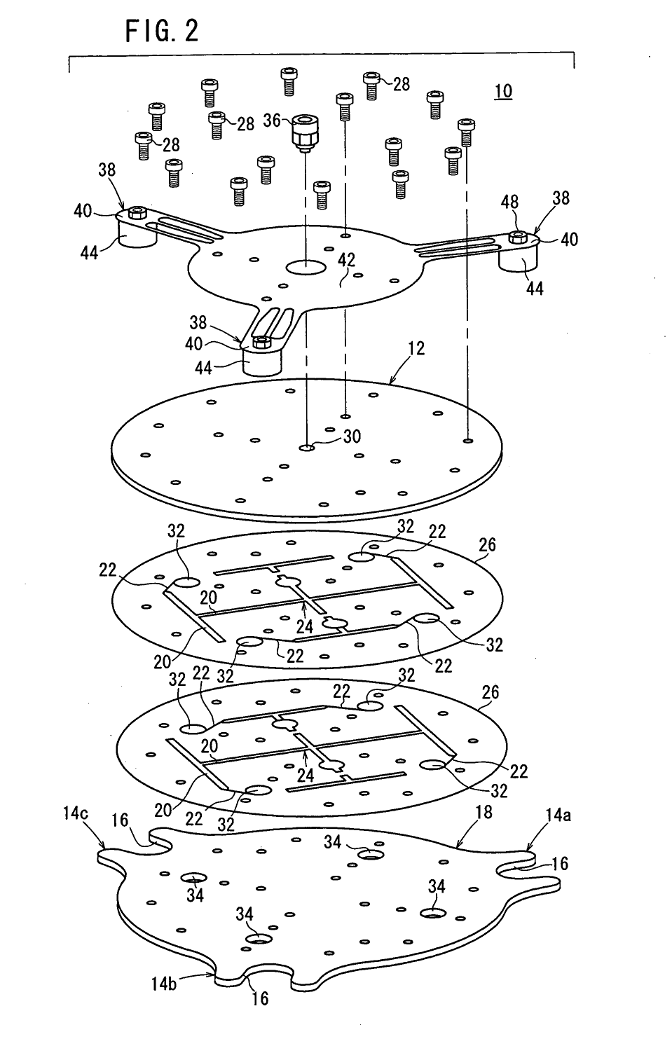

The non-contact transport apparatus 10 comprises a top plate 12, which is formed to be disk-shaped, an under plate 18, which is substantially disk-shaped and has curved recesses 16 formed by forked sections 14a to 14c expanded radially outwardly at three outer circumferential positions separated from each other by equal angles, a plurality (two in FIG. 2) of intermediate plates 26, which are stacked between the top plate 12 and the under plate 18 and are formed with slits 24 therein functioning as fluid passages 20 and nozzles 22, and a plurality of screw members (fastening mechanisms) 28, which integrally fasten the top plate 12, the intermediate plates 26, and the under plate 18 stacked as described above.

As shown in FIG. 2, the intersecting slit 24, which communicates with an air supply hole 30 of the top plate 12 as described later on, is formed in the intermediate plate 26. The slit 24 includes the fluid passage 20, which has a wide slit width perpendicular to the extending direction, and the nozzle 22 which communicates with the fluid passage 20. The nozzle 22 has a straight form, with a minute slit width, and is formed so as to be inclined radially inwardly.

The intermediate plate 26 is formed with four circular holes 32 therein, which communicate with the nozzles 22. The circular holes 32 further communicate with four air-jetting holes 34 formed in the under plate 18, as described later on respectively. The upper side intermediate plate 26 and the lower side intermediate plate 26, as shown in FIG. 2, have the same structure and slit shape, and are arranged simply by reversing the front and back of each other.

Intermediate plates 26 having various planar shapes and thicknesses are prepared and can be freely changed or recombined depending on the state of the workpiece. By recombining intermediate plates 26, it is possible to freely adjust the dimension in the thickness direction of the fluid passage 20 and the nozzle 22, by superimposing a desired number of intermediate plates 26 having the same planar shape. For example, when the thickness of the intermediate plate 26 is set to be about 0.1 to 0.5 mm, it is possible to establish an arbitrary thickness by combining and stacking a plurality of intermediate plates 26.

Intermediate plates 26 having the same planar shape may be produced by stacking plate members and collectively cutting them by means of wire cutting, even if the respective intermediate plates 26 have different thicknesses. A plurality of intermediate plates 26 are interposed between the top plate 12 and the under plate 18.

The air supply hole 30 is formed at a central portion of the top plate 12. A joint 36, which is connected to a compressed air supply source via an unillustrated tube, is fitted to the air supply hole 30. The four air-jetting holes 34 are arranged in the under plate 18 while being separated from each other respectively. A transport objective can be retained in a non-contact manner, utilizing the Bernoulli effect brought about by the air flow such that the air, which is supplied from the air supply hole 30, is orbited while protruding in the inner circumferential direction of the air-jetting holes 34, by the aid of the slits 24 (nozzles 22) formed in the intermediate plates 26. The top plate 12 and the under plate 18 are formed respectively by means of laser cutting.

The top plate 12, the intermediate plates 26, and the under plate 18 are formed by being cut from plate members respectively. For example, the flatness and roughness of the joining or bonding surfaces of each of the various plates may be exactly as those of the raw materials, and no processing or machining needs to be applied to such raw materials. A large number of fastening points between the plates, which are positioned for the screw members 28, are optimized and arranged corresponding to the applied stress thereof. Therefore, air leakage is avoided, even when seals are not especially provided between the respective plates.

The top plate 12 and the under plate 18 each has a thickness (for example, a material made of SUS having a thickness of 3 mm) which exceeds requirements in view of the fluid force (strength as a pressure tube passage) of the non-contact transport apparatus 10, according to the embodiment of the present invention, in order to respond to the strength requirements of the screw fastening per se and conversion of the screw fastening force into a sheet force between the respective plates to effect force distribution.

Performance of the non-contact transport apparatus 10 can be conveniently modified by the user. It is possible to perform adaptive operations corresponding to the installation environment. In the present arrangement, performance can be changed with ease by detaching the screw members 28 that fasten the plurality of stacked plates, and exchanging the intermediate plates 26 with other intermediate plates (not illustrated).

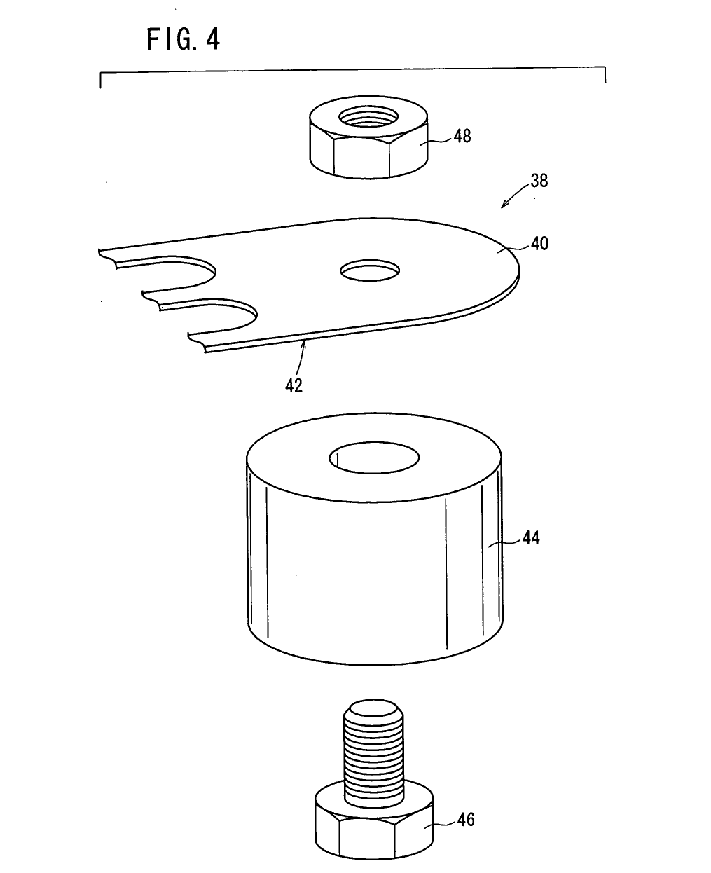

A disengagement-preventive guide mechanism 38 is provided at the outer circumference of the top plate 12 and the under plate 18. As shown in FIG. 4, the disengagement-preventive guide mechanism 38 includes a spring plate 42, which is arranged on the upper surface of the top plate 12, and which is formed with three tongues 40 having spring forces, cylindrical guide members 44 fixed to the tongues 40, and bolts 46 and nuts 48 that attach the guide members 44 to the tongues 40 of the spring plate 42.

The disengagement-preventive guide mechanism 38 restricts the degree of freedom of the workpiece in the horizontal direction, during non-contact transport thereof, so that the workpiece is prevented from becoming disengaged from the non-contact transport apparatus 10. The cylindrical guide member 44 is formed of an elastic member such as fluoro rubber. The guide members 44 are connected by the tongues 40 of the spring plate 42, which have a spring property, so that the guide members 44 are displaceable obliquely upwardly by deformation of the tongues 40. As a result, damage is avoided, which might otherwise be caused by collision against the guide members 44.

The non-contact transport apparatus 10 according to the embodiment of the present invention is basically constructed as described above. Next, its operations, functions and effects shall be explained.

Air is supplied from an unillustrated air supply source to the air supply hole 30, via an unillustrated tube connected to the joint 36. Air, which is supplied to the air supply hole 30, is introduced along the slits 24 of the intermediate plates 26. Air passes through the fluid passages 20, the nozzles 22, and the circular holes 32, to be blown into the plurality of air-jetting holes 34 respectively. Further, the air is rectified, while forming a swirling flow, in the internal spaces of the respective air-jetting holes 34. Air flows outwardly as a high speed flow toward the workpiece, from each of the air-jetting holes 34.

When the swirling flow of air flows outwardly from the air-jetting holes 34, the workpiece (for example, a wafer), which is arranged at a position opposed to the under plate 18, is attracted as a result the negative pressure generated by the high speed flow, while the workpiece receives a repulsive force due to the air (positive pressure) intervening between the under plate 18 and the workpiece. The workpiece is retained in a non-contact state, owing to the balance between the negative and positive pressures, while the workpiece is transported to a predetermined position.

The positive and negative pressures, which act on the workpiece, are changed by the clearance between the under plate 18 and the workpiece. That is, when the clearance is decreased, negative pressure is decreased and positive pressure is increased. On the other hand, when the clearance is increased, negative pressure is increased and positive pressure is decreased. In such circumstances, the workpiece to be lifted can be subjected to an optimum clearance, owing to the balance among the weight of the workpiece itself, the positive pressure, and the negative pressure. Thus, in this situation, the total lifting force exerted on the workpiece has a value depending on the weight of the workpiece itself, and the workpiece can be lifted by a minimal lifting force. This effect makes it possible to transport, for example, a film-shaped workpiece, such as a wafer that is easily deformable by external forces, without imposing undue strains or causing damage to the workpiece.

On the other hand, in the case of the conventional non-contact transport apparatus, a problem arises in that a distribution is generated in relation to the positive and negative pressures around the jetting holes (recesses 1), and strains are imposed on the workpiece due to such a distribution. In particular, when the workpiece is lifted in accordance with the action of a single jetting hole or a relatively small number of jetting holes (recesses 1), then the lifting amount, which is imposed by one of the jetting holes (recesses 1), increases and the tendency described above is facilitated.

In the conventional apparatus, the negative pressure, which serves as the origin of the lifting force, is generated about the center of the central portion of the jetting hole (recess 1). Therefore, the workpiece hangs downwardly due to its own weight at portions that are separated from the jetting hole (recess 1), thus causing strain on the workpiece.

Further, the workpiece, which has a film-shaped form that is easily deformed by external forces, tends to be deformed by local load imbalances. Therefore, in the conventional apparatus, a balancing action, effected by the weight of the workpiece itself, and the positive and negative pressures, does not occur, so that optimization of the lifting force cannot be achieved.

Therefore, in order to transport a workpiece having a film-shaped form which is easily deformable by external forces, in a non-contact manner without causing strain thereto, a large number of air-jetting holes 34 must be provided, as in the embodiment of the present invention, so that the lifting force produced by any one of the air-jetting holes 34 is kept small, and strains resulting from a pressure distribution around any single air-jetting hole 34 are suppressed. When the area of the workpiece imposed on any one of the air-jetting holes 34 is suppressed in this manner, it is possible to prevent downward hanging of the workpiece, which would be otherwise caused by the weight of the workpiece itself, at the portions that are distanced from the air-jetting hole 34.

In the embodiment of the present invention, a series of load changes, involving negative pressure→positive pressure→weight of the workpiece itself, are distributed over a short work span (area) by providing a large number of air-jetting holes 34. Accordingly, apparent rigidity of the workpiece is enhanced relatively with respect to pressure change (for example, as if the intervals of bridge piers are narrowed in a figurative sense), and thus it is possible to suppress strains on the workpiece. Therefore, in the embodiment of the present invention, the film-shaped workpiece, which is easily deformable by external forces, can be transported in a non-contact state without causing strains on the workpiece, by providing such a large number of air-jetting holes 34.

In the embodiment of the present invention, the air-jetting holes 34 are formed in the under plate 18, the circular holes 32, which communicate with the air-jetting holes 34, are formed in the intermediate plates 26, and the nozzles 22, which are composed of slits 24 having a narrow width in the tangential direction and which communicate with the circular holes 32, are provided so that air is jetted from the nozzles 22 at high speed. Accordingly, high speed swirling flows of air are generated in the circumferential direction, with respect to each of the air-jetting holes 34. One or more nozzles 22 are appropriately provided for each air-jetting hole 34. The diameter (slit width) of the nozzle 22 is on the order of several hundred μm. The air-jetting holes 34 and the nozzles 22, as well as certain other components, have performance characteristics with respect to negative pressure, positive pressure, the pressure distributions thereof, air consumption amount, and supply pressure, depending on the dimensional shapes and arrangements thereof, respectively.

Ordinarily, when the number of the air-jetting holes 34 is increased, the number of forming steps is usually increased along therewith. However, when a plurality of intermediate plates 26 are used in a stacked fashion, which have the same slit shape, and such intermediate plates 26 are interposed between the top plate 12 and the under plate 18, as in the embodiment of the present invention, then it is possible to decrease the number of forming steps and reduce production costs.

In the embodiment of the present invention, the fluid passage 20 and the nozzle 22, which communicate with the air-jetting hole 34, are formed integrally, having a slit-shaped form of about several hundred μm. The slit 24 may be formed simply in the intermediate plate 26 using a sheet-shaped material, in which the planar surface of the material can be used as is. It is unnecessary to apply a large number of forming steps for producing the sheet surface.

Further, in the embodiment of the present invention, the flow rate of air is controlled by the fluid passage 20, which is formed in the intermediate plate 26. The air flow within the air-jetting hole 34 is controlled by the shape of the nozzle 22 as well as the number thereof (i.e., the number of nozzles provided per one air-jetting hole 34). The thickness of the intermediate plate 26 also affects the performance of both. Therefore, the attracting performance can be controlled by properly designing the intermediate plate 26. Consequently, the portion concerning the attracting performance is provided as a unified independent part. Various requests for attracting performance can be easily realized and optimized, for example, by manufacturing different types of intermediate plates 26, by way of trial, and exchanging, recombining, and/or combining such intermediate plates 26.

Other portions of the non-contact transport apparatus 10, according to the embodiment of the present invention, can be produced as common parts, with respect to various requests for attracting performance. Therefore, it is possible to respond to the need for limited production of diversified products, i.e., manufacturing of a wide variety of products in small quantities. When performance requirements are changed, it is possible to verify such requirements by designing and exchanging the intermediate plates 26. Hence, the number of designing steps can be reduced.

Further, the intermediate plates 26 are exchangeable in the final product as well, and thus the end user also can freely make such recombinations, in conformity with desired performance requirements, by making adjustments or the like.

When the intermediate plates 26 are formed, it is preferable to use any of several manufacturing methods, for example, machining processing, laser cutting, wire cutting, photoetching, electroforming, and sheet metal pressing.

The manner in which the intermediate plates 26 are formed is determined depending on a balance between the number of products to be made and production cost. For example, when the number of devices to be made is small, for use in trial manufacturing or the like, it is useful to adopt a manufacturing method such as machining processing or laser cutting. On the other hand, when the total number of intermediate plates 26 to be formed is about 10 sheets, then a plurality of plates may be stacked together and manufactured collectively by means of a wire cutting method, and thus production costs can be reduced, because the process for forming the intermediate plates 26 is directed to the slits.

When the thickness of the intermediate plate 26 is no more than several hundred μm, it is useful to adopt, for example, a photoetching or electroforming method, in which the nozzles 22 can be formed with higher accuracy. In the case of photoetching and electroforming, the complexity of the slit shape does not affect the number of required manufacturing steps. Therefore, photoetching and electroforming methods are useful when it is desired to form a large number of air-jetting holes 34, or to form holes for realizing a lightweight structure and accurate control of air flow.

Formation processing of the intermediate plates 26 is directed only to forming the slit 24. Therefore, the forming methods described above may be used interchangeably, wherein an optimum processing method may be selected depending on, for example, development and design steps, and product manufacturing in relation to a particular product series. The manufacturing process may be shifted, and another different forming method may be used, in response to various changes in situations and manufacturing requirements.

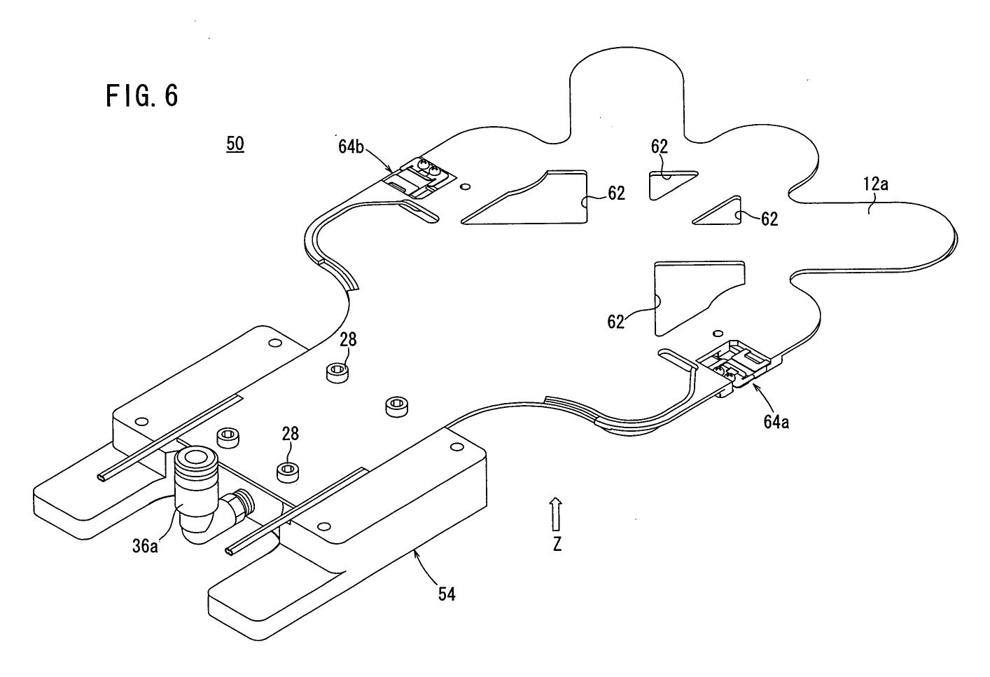

A non-contact transport apparatus 50 according to another embodiment of the present invention is shown in FIGS. 6 to 19. The same constitutive components as those of the embodiment described above are designated using the same reference numerals, wherein corresponding constitutive components are expressed by affixing small letters to the same reference numerals, and detailed explanations thereof shall be omitted.

The non-contact transport apparatus 50 according to this embodiment comprises various plates, which are constructed to have a total thickness of about 3.2 mm by collectively performing diffusion bonding on sixteen sheets of photoetching plates made of stainless steel, each having a thickness of about 0.2 mm.

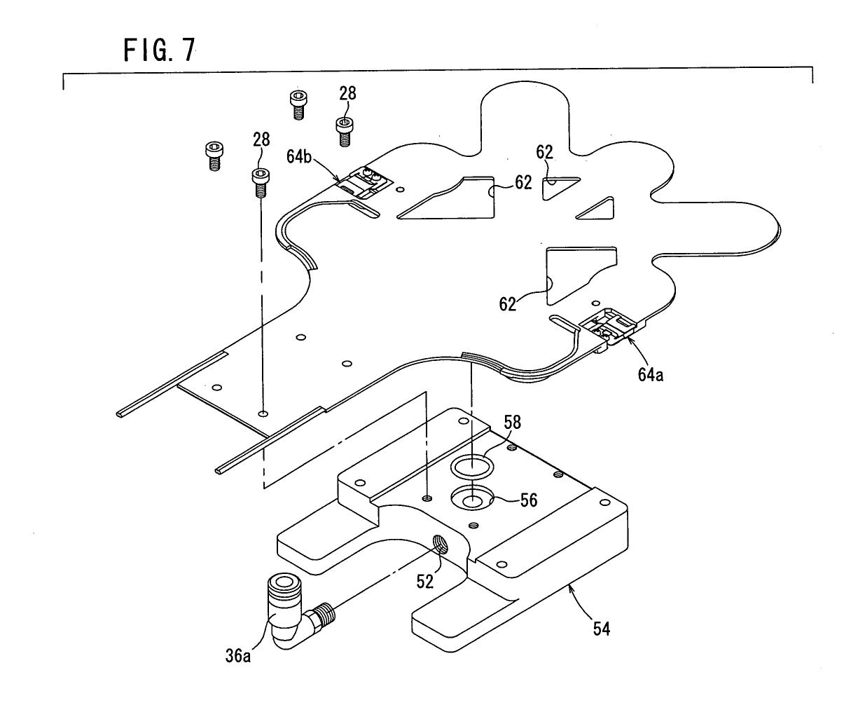

As shown in FIG. 7, the non-contact transport apparatus 50 has a box-shaped main apparatus body 54, which is provided with an air-introducing port 52 for installing an L-shaped bent joint 36a therein, and to which the sixteen sheets of various plates are connected by the aid of screw members 28. An annular recess 56 is formed on the upper surface of the main apparatus body 54. An O-ring 58, which exhibits a sealing function with respect to the stacked plates, is installed in the annular recess 56.

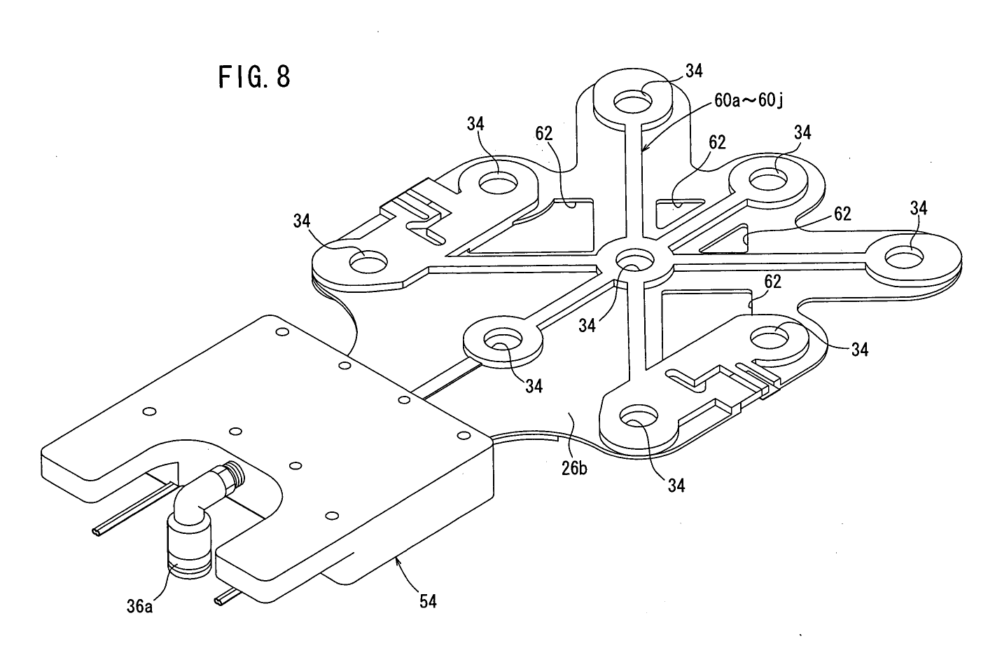

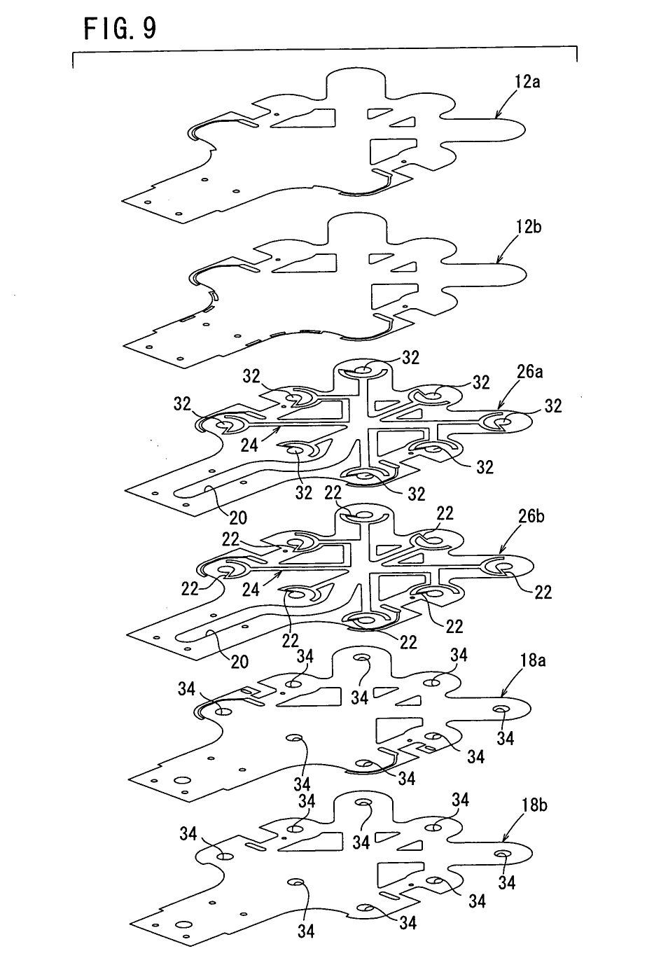

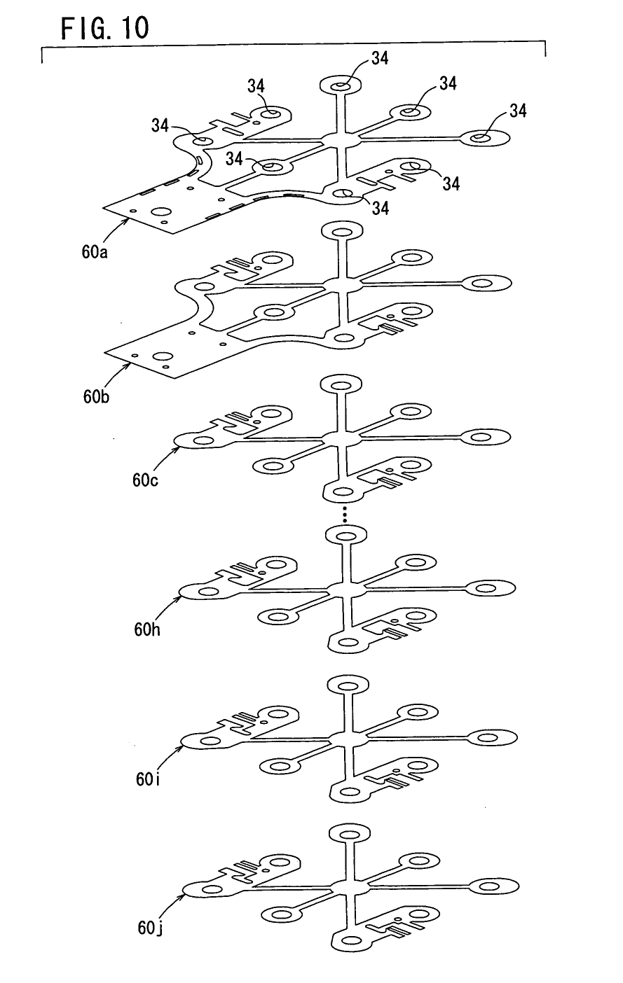

As shown in FIG. 9, the sixteen sheets of various plates, which are stacked and formed integrally, are roughly classified, according to their principal functions, into two stacked sheets of top plates 12a, 12b, two stacked sheets of intermediate plates 26a, 26b, two stacked sheets of first under plates 18a, 18b, and ten stacked sheets of second under plates 60a to 60j (see FIG. 10). The first under plates 18a, 18b have the same function as that of the under plate 18 shown in FIG. 2, in order to form a three-dimensional structure of fluid passages 20 together with the intermediate plates 26a, 26b, and having pressure resistant walls disposed at both ends thereof. The ten sheets of second under plates 60a to 60j are integrally stacked, and thus are formed to provide cylindrical structures of air-jetting holes 34 (see FIG. 8).

Because they are formed by means of photoetching, the intermediate plates 26a, 26b are stably formed and have high dimensional accuracy. Photoetching provides a highly excellent forming method, because no special management steps need to be taken in order to ensure and maintain such dimensional accuracy.

The workpiece may come into contact with the second under plates 60a to 60j. Therefore, the second under plates 60a to 60j should be formed so as to have a planar shape to a minimum extent. A plurality of cutaway sections 62 are provided, at portions which do not relate to the lifting operation (see FIGS. 6 and 8). The cutaway sections 62 have important implications for the fluid action of the air-jetting holes 34, along with providing cutaway portions which are open while enabling communication from the top plates 12a, 12b to the first and second under plates 18a, 18b and 60a to 60j.

More specifically, a negative pressure, which is based on a swirling flow jetted at high speed from the air-jetting hole 34, is generated about the center of the swirling flow by means of centrifugal force brought about by swirling, similar to the state of an eye of a cyclone. Such negative pressure acts on the basis of the pressure around the air-jetting hole 34. In the vicinity of the air-jetting hole 34, air flows outwardly from the air-jetting hole 34, wherein the air flow passes along the outer edge portions of the air-jetting hole 34 parallel to the workpiece, and then is discharged to the outside (i.e., into atmospheric air). Since the air flow is discharged to atmosphere, the pressure around the air-jetting hole 34 has a value larger than that of atmospheric pressure, by an amount of pressure loss occurring at the outer edge portions of the air-jetting hole 34 parallel to the workpiece. In other words, a positive pressure is generated at a location ranging from the outer edge portions of the air-jetting hole 34 to the portion that is open to atmospheric air. The positive pressure provides an effect such that contact between the workpiece and the apparatus is avoided.

However, when the pressure loss is large, there is a possibility that the negative pressure, which is generated relatively at the central portion of the swirling flow, may be an extremely small negative pressure, or a positive pressure, on the basis of atmospheric pressure. Therefore, a reduction of the pressure loss provides an effect which increases the negative pressure. Pressure loss is affected by the clearance between the workpiece and the outer edge portions of the air-jetting hole 34, as well as the length of the portion of the air-jetting hole 34 that is perpendicular to the circumferential direction of the swirling flow. As a result of this fact, the distance from the air-jetting hole 34 to the portion open to atmospheric pressure, and the clearance between the workpiece and the apparatus over the range to arrive thereat, are extremely important factors influencing attracting performance.

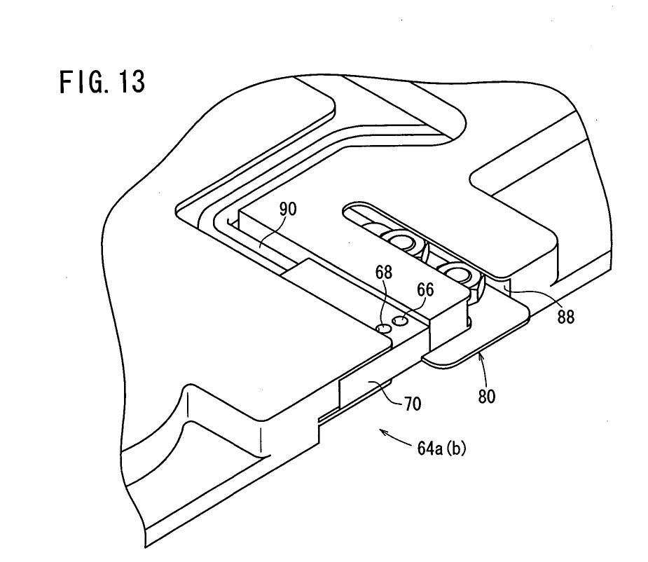

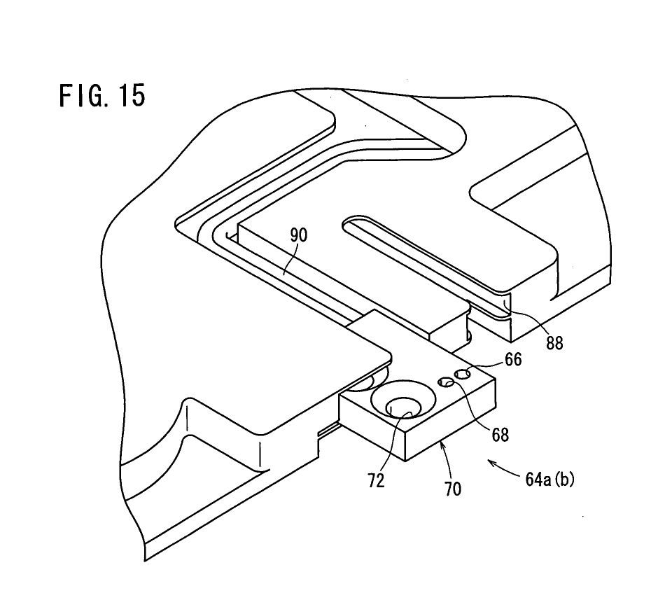

In the present embodiment, a pair of reflection type photoelectric sensor mechanisms 64a, 64b are installed on the non-contact transport apparatus 50, in order to confirm attraction of the wafer in a non-contact state. The photoelectric sensor mechanism 64a (64b) is capable of detecting the presence or absence of the workpiece, by means of a light beam, which is radiated from a sensor light-projecting hole 66 directed toward the workpiece, wherein a reflected light beam is received by another sensor light-receiving hole 68 disposed adjacent to the sensor light-projecting hole 66 (see FIGS. 13 and 15). Attachment holes 72, which are used to attach a main sensor body 70 to the various stacked plates, are formed through the main sensor body 70, and are disposed closely to the sensor light-projecting hole 66 and the sensor light-receiving hole 68.

In order that the workpiece may be disengaged by pealing it away from the apparatus, a state in which the workpiece is only partially attracted is brought about during an initial stage of performing such disengagement. Therefore, the pair of photoelectric sensor mechanisms 64a, 64 are arranged, and an attraction state of the workpiece is detected by obtaining an AND signal from the respective output signals of the pair of photoelectric sensor mechanisms 64a, 64b.

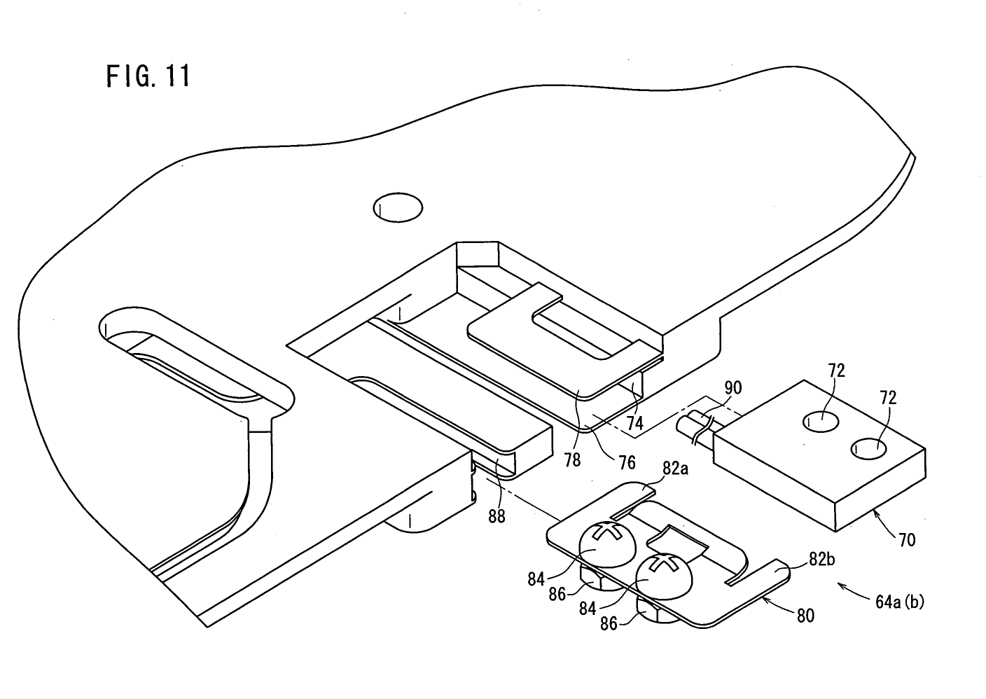

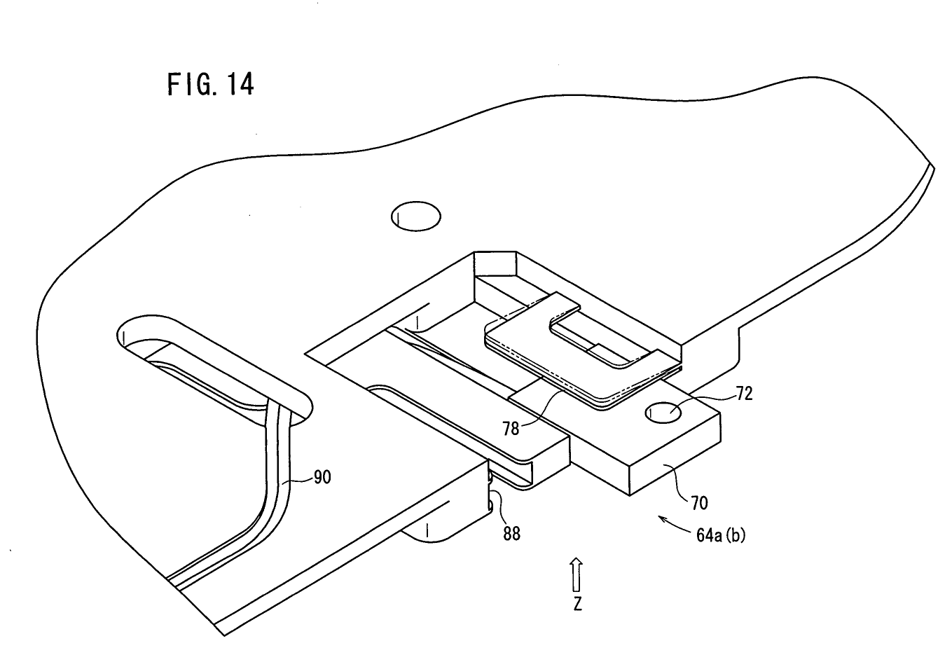

As shown in FIG. 11, a fitting groove 74, which is slightly larger than the widthwise dimension of the main sensor body 70, is formed within the various stacked plates. A first fin 76 (thickness: about 0.2 mm) is formed at a lower portion of the fitting groove 74 (on the side of the workpiece), while causing no interference with the optical axis of the sensor. A second fin 78 (thickness: about 0.2 mm), which conforms to the height of the sensor, is formed at an upper portion of the fitting groove 74 (on the side of the workpiece), in order to temporarily fix the sensor. The second fin 78 is formed in the shape of a plate spring, and is provided with a spring property. Hence, the second fin 78 is deformable upwardly corresponding to the dimension of the main sensor body 70, in the event that the height dimension of the main sensor body 70 is not precisely accurate (see FIG. 14).

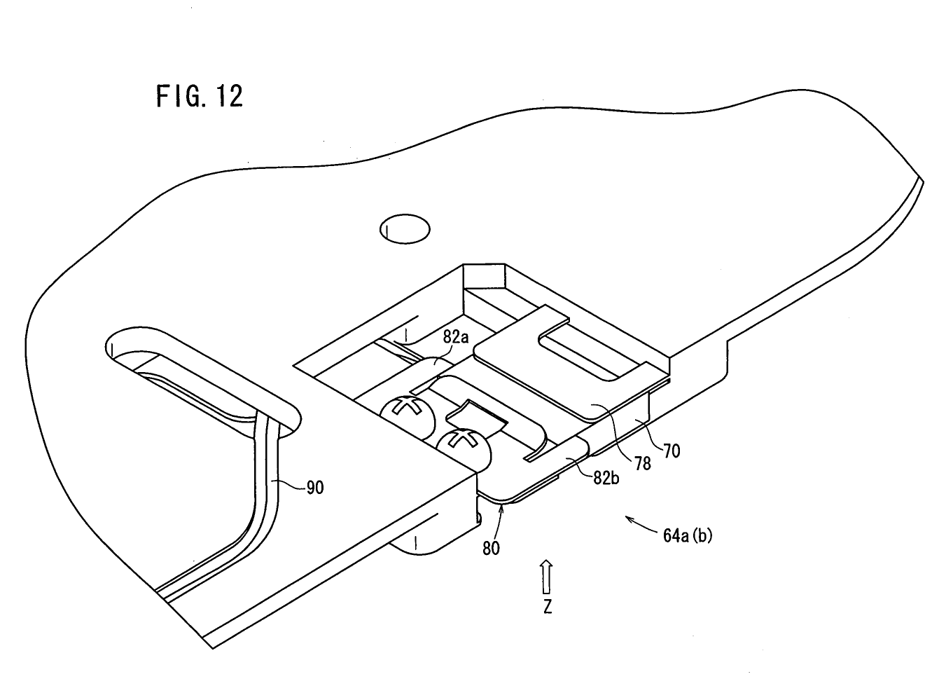

As shown in FIG. 12, the main sensor body 70 is fixed by being interposed between a pair of pawls 82a, 82b in a sensor plate 80, which are separated from each other by a predetermined spacing distance. The sensor plate 80 is simultaneously formed together with the other plates, when they are formed by means of photoetching. The sensor plate 80 is formed by a metal plate, having a thickness of, for example, about 0.2 mm.

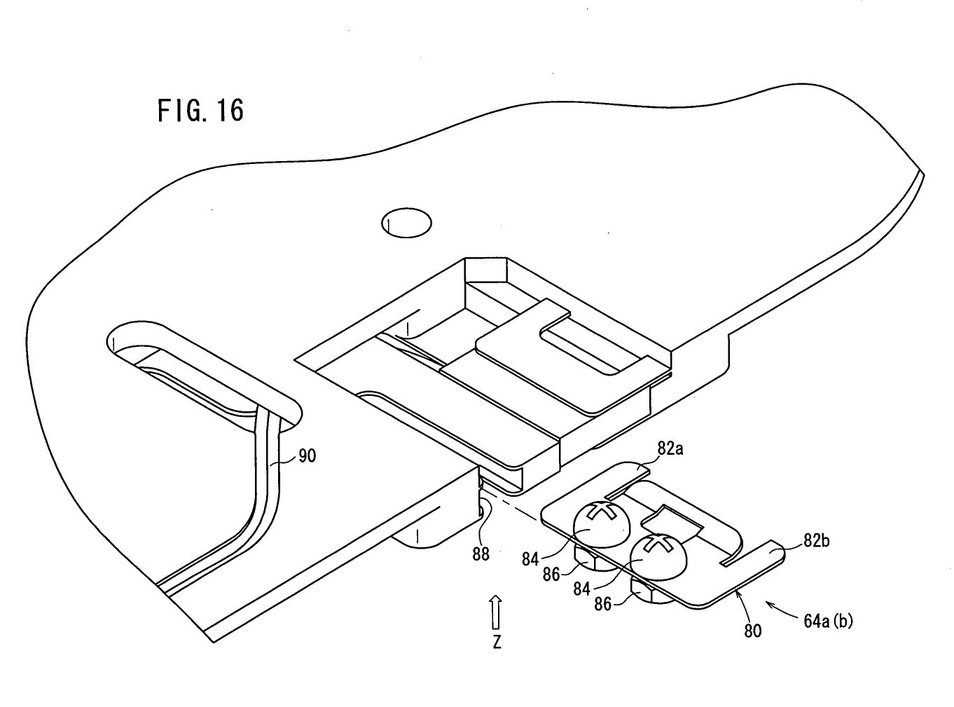

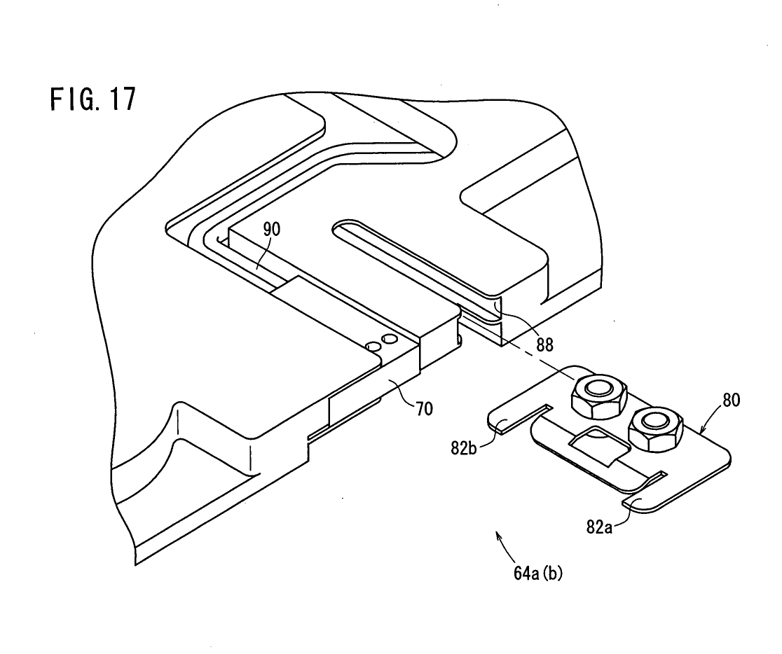

Two pairs of screws 84 and nuts 86 are provided for the sensor plate 80. The sensor plate 80 is fixed by the aid of a nut-inserting groove 88, into which the nuts 86 are inserted. In the present arrangement, the main sensor body 70 is retained by the pair of pawls 82a, 82b, and thus the main sensor body 70 is fixed. The sensor plate 80 is fixed in place by installing the nuts 86 along the nut-inserting groove 88 formed on the side of the main sensor body 70 (see FIGS. 16 and 17).

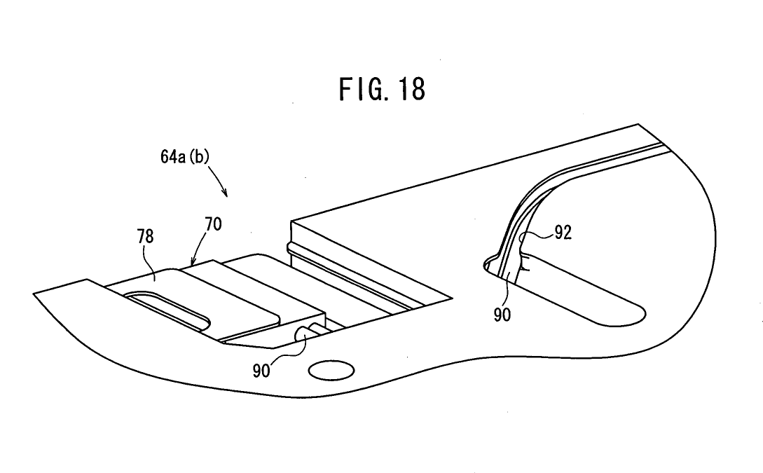

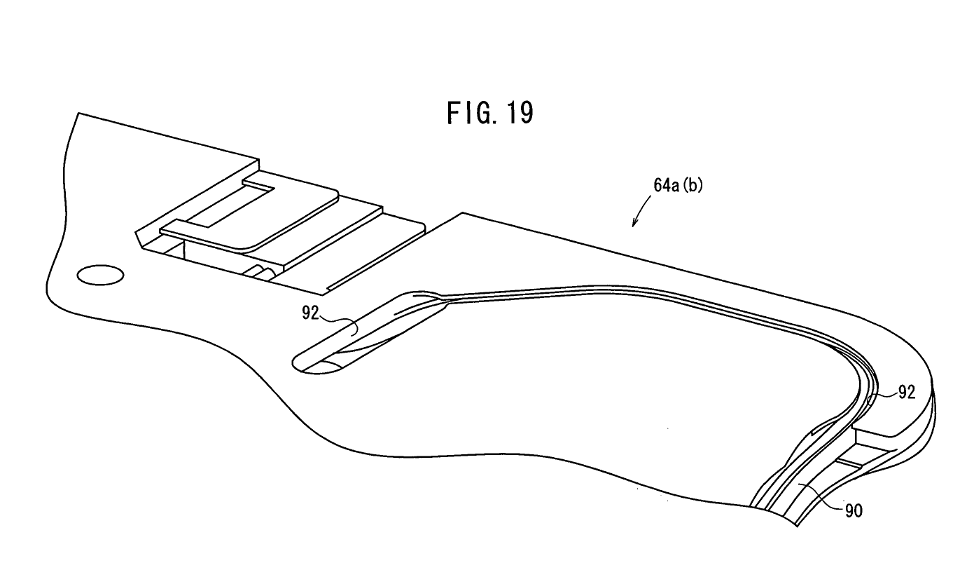

A cable 90, which extends from the main sensor body 70, is subjected to directional change at predetermined angles, in order to effect handling thereafter. A flexibly bendable cable 90 is used in order to effect such directional change. The cable is inserted into a groove 92, which is provided on the upper surface side of the sensor mechanism (i.e., a surface disposed on the side opposite to the workpiece). The groove 92 is formed to have a substantially C-shaped cross section with a narrow opening, wherein an internal space, which extends from the opening inwardly, is designed to be wide. In this structure, the cable 90, which is inserted into the groove 92, does not become detached from the groove 92 and does not protrude outwardly from the groove 92 (see FIGS. 18 and 19).

When the various plates are joined or bonded by means of diffusion bonding, sufficient strength and sealing performance are provided, in order to form fluid passages 20 inside a thin type of apparatus arrangement. All of the various plates can be collectively stacked and bonded together without increasing the number of bonding steps. By selecting an arbitrary combination of intermediate plates 26a, 26b before performing diffusion bonding, it is possible to make variations and modify various performance characteristics of the apparatus with ease.

Diffusion bonding, which functions as the bonding mechanism, is a bonding method that utilizes a diffusion phenomenon of metal atoms. Specifically, metal surfaces are allowed to approach each other mutually, at an atomic level, followed by being integrated metallurgically into one unit, by causing a diffusion phenomenon to occur between both parts using a heating and pressurizing mechanism in order to effect bonding.

The portion bonded by the diffusion phenomenon generally occupies not less than several ten percent of the overall structure, but may differ depending on, for example, connecting conditions, surface roughness, and flatness. Therefore, in addition, the strength of the entire bonded surface is not less than several ten percent of the strength of the original metal. The portion bonded by the diffusion phenomenon is uniformly distributed over the entire region of the bonded surface, and therefore a gas tight seal can be achieved.

When diffusion bonding is used as described above, a large number of stacked sheets can be collectively bonded. When such bonding is performed, a plurality of sheets are simply stacked, pressurized, and thereafter heated in a vacuum furnace. Even when diffusion bonding is performed at a plurality of portions of one product, the number of forming steps need not be affected, provided that such bonding is performed collectively. Therefore, when a three-dimensional structure is required at portions other than the intermediate plates 26a, 26b, diffusion bonding may be performed simultaneously for the intermediate plates 26a, 26b as well as the other plates, without independently bonding and forming only the intermediate plates 26a, 26b. Accordingly, the number of forming steps is reduced, which is effective in reducing production costs.

Other functions and effects are the same as those of the embodiment described above, and detailed explanations thereof shall be omitted.

Although certain preferred embodiments of the present invention have been shown and described in detail, it should be understood that various changes and modifications may be made therein without departing from the scope of the appended claims.

What is claimed is:

1. A non-contact transport apparatus comprising:
a top plate disposed on one side, which has an air supply hole and which is formed to have a planar shape;
an under plate disposed on the other side, which has a plurality of air-jetting holes and which is formed to have a planar shape;
a plurality of intermediate plates, which are interposed between said top plate and said under plate, and which are formed with slits therein functioning as nozzles and fluid passages that communicate with said air supply hole and said air-jetting holes; and
a fastening mechanism which integrally stacks and connects said top plate, said plurality of intermediate plates, and said under plate,
wherein said plurality of intermediate plates are integrally stacked and provided between said top plate and said under plate.

2. The non-contact transport apparatus according to claim 1, wherein said fastening mechanism includes screw members, and said plurality of intermediate plates are exchangeable by detaching said screw members.

3. The non-contact transport apparatus according to claim 1, wherein said under plate has curved recesses, which are formed by forked sections expanded radially outwardly.

4. The non-contact transport apparatus according to claim 1, wherein said slit includes said fluid passage, which is disposed perpendicularly to an extending direction and has a wide slit width, and said nozzle, which communicates with said fluid passage and has a slit width narrower than that of said fluid passage.

5. The non-contact transport apparatus according to claim 4, wherein said nozzle is composed of a straight slit bent radially inwardly from said fluid passage.

6. The non-contact transport apparatus according to claim 1, wherein said plurality of intermediate plates have a predetermined thickness provided by stacking a desired number of said intermediate plates each having an identical thickness.

7. The non-contact transport apparatus according to claim 1, wherein said air supply hole is formed at a central portion of said top plate, and a joint is fitted to said air supply hole.

8. A non-contact transport apparatus comprising:
a main apparatus body, which is formed with an air-introducing port;
a plurality of top plates each of which is formed to have a planar shape;
first under plates each of which is formed to have a planar shape having air-jetting holes defined therein;
a plurality of second under plates connected to said first under plates, and which are stacked to form said air-jetting holes;
a plurality of intermediate plates interposed between said top plates and said first under plates, and which are formed with slits therein functioning as nozzles and fluid passages that communicate with said air-introducing port and said air-jetting holes; and
a connecting mechanism, which integrally connects said top plates, said plurality of intermediate plates, said first under plates, and said second under plates,
wherein said plurality of intermediate plates are stacked and provided between said top plates and said first under plates.

9. The non-contact transport apparatus according to claim 8, wherein said connecting mechanism is composed of diffusion bonding effected by integrally heating and pressuring said top plates, said plurality of intermediate plates, said first under plates, and said second under plates.

10. The non-contact transport apparatus according to claim 8, wherein cutaway sections are provided for said top plates, said plurality of intermediate plates, and said first under plates, respectively, except for said second under plates.

11. The non-contact transport apparatus according to claim 8, further comprising a pair of sensor mechanisms for confirming attraction of a workpiece in a non-contact state.

12. The non-contact transport apparatus according to claim 11, wherein each of said sensor mechanisms has a main sensor body, said main sensor body being installed in a fitting groove formed by a first fin and a second fin.

13. The non-contact transport apparatus according to claim 12, further comprising sensor plates, each of which interposes said main sensor body between a pair of pawls.
